(19) United States
(12) Patent Application Publication
(10) Pub. No.: US 2026/0260208 A1
(43) Pub. Date: Sep. 3, 2026

(54) USING MACHINE-LEARNING VISION LANGUAGE MODELS TO IDENTIFY INTERCHANGEABLE ITEMS

(71) Applicant: Maplebear Inc., San Francisco, CA (US)

(72) Inventors: Venkata Satya Pradeep Karuturi, Los Angeles, CA (US); Qiao Qiao, Ames, IA (US); Prithvishankar Srinivasan, Seattle, WA (US); Shishir Kumar Prasad, San Ramon, CA (US)

(21) Appl. No.: 19/068,873

(22) Filed: Mar. 3, 2025

(51) Int. Cl. G06Q 10/087

(52) U.S. Cl. CPC G06Q 10/087

(57) ABSTRACT

A system determines whether an item is an acceptable force mark with an ordered item. The system receives an order that includes an item and a set of acceptable scan codes associated with the item. The system receives a selected a second item as fulfillment of the ordered item. The system identifies whether a second scan code of the second item is included in the set of acceptable scan codes associated with the ordered item. In response to identifying that the second scan code is not included in the set of acceptable scan codes, the system applies a multi-modal model to determine whether the second item is interchangeable with the ordered item. In response to receiving a response from the multi-modal model that the second item is interchangeable with the ordered item, the system provides an indication that the second item is approved for fulfillment.

### BACKGROUND

An online system receives orders from users to fulfill one or more items by a picker. The picker fulfills items in the order at a retailer store. A force mark is a scenario that may occur when a picker scans an item they have picked to fulfill an order, but the item is not recognized by the online system because its machine-readable code (e.g., scan code) captured by an image capture device of a computing device does not correspond to the retailer catalog's scan code of the ordered item. Subject to certain conditions, the picker can force mark the item as being fulfilled even if the machine-readable code of the picked item did not correspond to the scan code of the ordered item. This can occur, for example, because the picked item is a duplicate or interchangeable item with the ordered item, but the retailer catalog does not incorporate this item because the database has not been updated. However, force marks can cause issues such as overspending or appeasements when the force mark item does not correspond to the ordered item. Therefore, there exists a need to identify whether a picked item may be interchangeable, or force marked, with a corresponding item in the order when the picker is fulfilling the item at the retailer store. Force marks present a unique technologically difficult problem, as the scan code of the picked item is often not available in the retailer's catalog database.

### SUMMARY

In accordance with one or more aspects of the disclosure, the online system determines whether an item is an acceptable force mark to an ordered item. The online system may receive an order from a user that includes an item, wherein the item is associated with a first machine-readable code (e.g., scan code) and a set of acceptable scan codes. The set of acceptable scan codes are the scan codes that the online system recognizes to associate with the ordered item. The online system receives, from a picker computing device, an indication that a picker selected a second item as fulfillment of the item in the order, wherein the second item is associated with a second scan code. In response to determining that the second scan code of the second item does not match the first scan code of the item, the online system may identify whether the second scan code is included in the set of acceptable scan codes associated with the ordered item. The online system, in response to identifying that the second scan code is not included in the set of acceptable scan codes, may obtain an image of the second item captured by the picker computing device and prompt a multi-modal transformer model. The prompt to the multi-modal transformer model includes as input a prompt that includes the image of the second item, a text description of the item, and a request to determine whether the second item is interchangeable with the ordered item. In response to receiving a response that the second item is interchangeable with the ordered item, the online system may provide an indication to the picker computing device that the second item is approved for fulfillment. The online system may store the second item as an acceptable scan code for the ordered item.

### BRIEF DESCRIPTION OF THE DRAWINGS

FIG. 1A illustrates an example system environment for an online system, in accordance with one or more aspects described herein.

FIG. 1B illustrates an example system environment for an online system, in accordance with one or more aspects described herein.

FIG. 2 illustrates an example system architecture for an online system, in accordance with one or more aspects described herein.

FIG. 3 illustrates a flowchart for identifying whether a scanned item is a match to the ordered item, in accordance with one or more aspects described herein.

FIG. 4 is a flowchart for determining a set of acceptable scan codes associated with the ordered item for an offline approach, in accordance with one or more aspects described herein.

FIG. 5 illustrates a flowchart for prompting a multi-modal large language model (LLM) to identify duplicates or interchangeable items for an online approach, in accordance with one or more aspects described herein.

FIG. 6 is a flowchart for a matching item module, in accordance with one or more aspects described herein.

### DETAILED DESCRIPTION

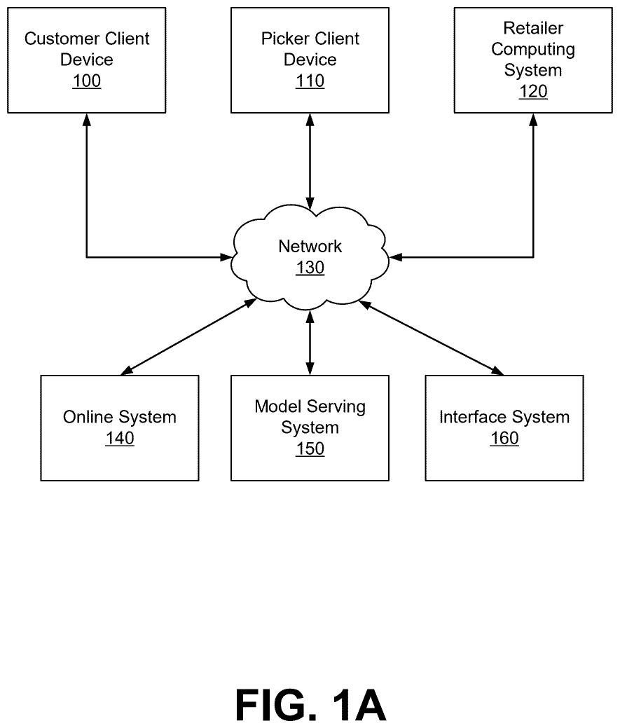

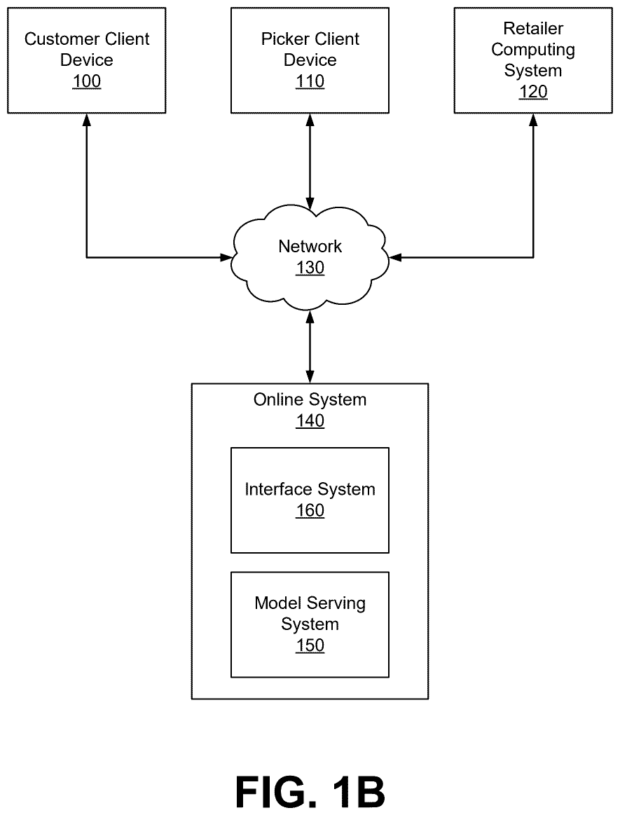

FIG. 1A illustrates an example system environment for an online system 140, in accordance with some embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provides portions of the payment from the customer to the picker and the retailer.

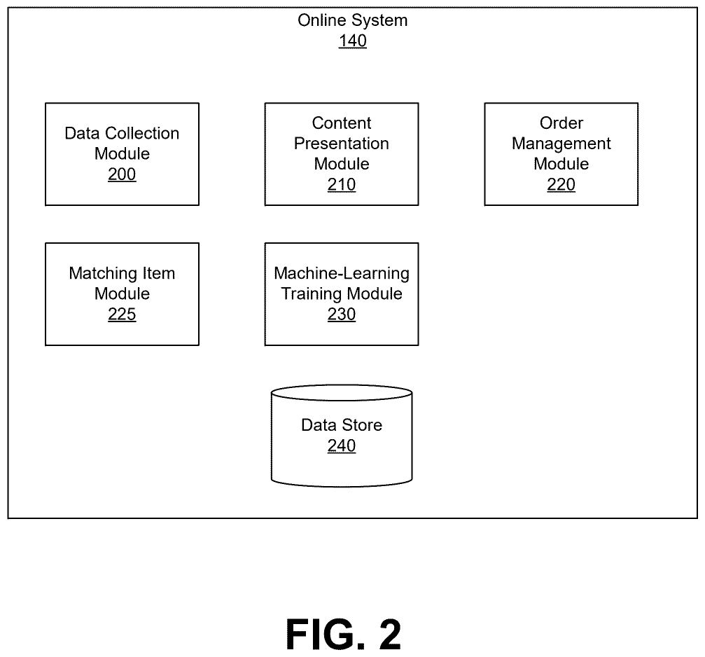

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one or more embodiments, the online system 140 determines whether an item is an acceptable force mark to an ordered item, where an acceptable force mark occurs when an item that is interchangeable to or an acceptable duplicate to the ordered item is picked to fulfill the user's order. Specifically, a force mark occurs when a picker computing device scans an item (e.g., scans a machine-readable code of the item, captures an image of the item, or the like) picked to fulfill an order, but the item is not recognized because its scan code does not match scan codes in the retailer's catalog. A scan code of an item is a machine-readable code identifying the item and may be created, for example, by the manufacturer of the item, a distributor of the item, and/or a retailer selling the item. In one or more embodiments, the scan code of the item is found displayed on a packaging of the item, on the item itself, or any appropriate medium associated with the item. The scan code may be formatted as a bar code, a quick-response (QR) code, and the like.

This discrepancy between the scan code of the picked item and the scan codes of the retailer's catalog leads to the scenario where the picker can still mark the item as fulfilled by indicating on an application of the online system, despite the mismatch in the catalog data. Force marks may occur when the picked item is not listed in the retailer catalog, there is a discrepancy between the picked item's scan code and the ordered item's scan code, there is a discrepancy between packaging or labeling of the picked item and the corresponding ordered item, or when there exists stocking and product variant issues. As an example, a force mark may occur when an ordered item for a “Sheer Satin Pink Ribbon” is scanned, but the updated packaging of the picked item does not match the previous packaging of the corresponding ordered item currently listed in the retailer's catalog. In such an example, the picker may force mark the ordered item as being fulfilled. For example, the picker may interact with one or more user interface (UI) elements generated by the application on a picker client device to indicate an ordered item as being fulfilled, although the scan code of the ordered item does not correspond to the scan code of the picked item.

Force marks typically arise when an item is picked that is not listed in the retailer's system or catalogue database, either due to catalog errors, inventory updates, or product variations that are not reflected in the retailer's catalog. The current practice of force marking allows the fulfillment to continue, but it can introduce issues, such as improper items being marked as fulfilled or misaligned inventory records. Therefore, addressing force marks is important for maintaining accurate order fulfillment, retailer catalog management, and user experience.

Force marks may also posit a distinct scenario from a replacement scenario. During a replacement scenario, the online system 140 identifies a candidate replacement item to the corresponding ordered item. The replacement candidate is identified within the retailer's catalog database with corresponding item identifiers, such as images and/or text-descriptions of the candidate items. During a force-mark scenario, the online system 140 might not have corresponding item identifiers of the scanned item. During a force mark scenario, the online system 140 may solely rely on an image of the item received from a picker client device and a scan code of the picked item.

In one or more embodiments, the online system 140 ensures accurate order fulfillment when a picker scans an item that doesn't match the original ordered item's scan code. The online system 140 may determine whether the scanned item's scan code is in a predetermined set of acceptable scan codes associated with the ordered item. If not, the online system 140 may include as input to a multi-modal machine learning model, an image of the scanned item, a text description of the scanned item, and a request to determine whether the scanned item is interchangeable with the ordered item. If approved, the picker is notified, and the scanned item's scan code is saved for future orders as an acceptable scan code of the ordered item.

A matching item may be an item that is identical, a duplicate, or interchangeable with the requested item. As an example, an identical item would be a 16-ounce jar of “Brand S Peanut Butter” with the same brand, size, flavor, and packaging as the ordered item. As another example, a duplicate item would be a 16-ounce jar of “Brand S Peanut Butter” with the same brand, size, flavor as the ordered item, but with a different scan code. This may occur when an item is from a different production batch, region, or packaging variation (e.g., one with a promotional label). An interchangeable item is an item that is an item that may be used interchangeably with the ordered item as they are effectively the same or substantially similar, or provides a benefit or advantage over the ordered item. As an example, if the ordered item is a 12-pack of “XX Soda,” and the retailer store currently has a promotion where a 14-pack of “XX Soda” is offered at the same price, the 14-pack would be considered interchangeable. Both items are effectively the same product, and the larger pack provides added value to the user without altering the fulfillment intent. However, the scan code of the ordered item in the catalogue database may be different from the interchangeable item present in the physical store.

In one or more embodiments, as described in further detail below, the online system 140 described herein may first perform an offline phase to identify a list of acceptable scan codes for each item that represent items interchangeable with the ordered item. Specifically, during the offline phase, the list of acceptable scan codes for an item may be generated by generating one or more embeddings for a set of items in the catalogue database of the online system 140, and determining an acceptable subset of items with corresponding scan codes to determine the acceptable set of scan codes associated with the item. The online system 140 may access a database including images and text descriptions for a set of items in a catalog. The online system 140 may apply an embedding model to generate image and text embeddings for both the item and the set of items in a catalog. Using these embeddings, the online system 140 identifies a set of nearest-neighbor items by identifying that the embeddings of the items in a catalog are within a threshold distance of the embeddings of the item. For each nearest-neighbor item, a multi-modal machine learning model includes a request to determine its interchangeability with the ordered item by receiving its image and text description as an input. If determined interchangeable, the online system 140 retrieves the scan codes of the nearest-neighbor item and stores them as part of the list of acceptable scan codes for the item.

When a picker scans an item for an ordered item in a user's order, the online system 140 may determine whether the scan code of the picked item corresponds to the scan code of the ordered item or is included in the list of acceptable scan codes for the ordered item that was built during, for instance, the offline phase. If not found, the online system 140 may perform an online phase. During the online phase, the online system 140 requests an image of the picked item, and determines the interchangeability with the ordered item by applying the image of the picked item with the multi-modal machine learning model. If determined to be interchangeable, the online system 140 may approve the purchase of the picked item and may also add the picked item to the list of acceptable scan codes for the ordered item. If determined not to be interchangeable, the online system 140 will not allow scanning and purchase of the picked item.

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

In one or more embodiments, for an order of a user, the online system 140 performs a query to a machine-learned model for pairing information. Specifically, the online system 140 provides external data relating to the pairing of alcohol and food to the model serving system 150. The online system 140 provides a request to the model serving system 150 to infer alcohol pairings for the order given the list of items and previous user shopping history for the user. The online system 140 receives a response to the prompt from the model serving system 150 based on execution of the machine-learned model. The online system 140 obtains the response and includes the external pairing data in the personalized recommendations for alcohol pairings to the user. In some embodiments, the online system 140 uses the external pairing data to sort the list of potential alcohol candidates into a final recommendation.

FIG. 1B illustrates an example system environment for an online system 140, in accordance with some embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weigh the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and offers the orders to pickers for service based on picker data. For example, the order management module 220 offers an order to a picker based on the picker's location and the location of the retailer from which the ordered items are to be collected. The order management module 220 may also offer an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to offer an order to a picker based on a delivery timeframe requested by the customer with the order. The order management module 220 computes an estimated amount of time that it would take for a picker to collect the items for an order and deliver the ordered item to the delivery location for the order. The order management module 220 offers the order to a picker at a time such that, if the picker immediately services the order, the picker is likely to deliver the order at a time within the timeframe. Thus, when the order management module 220 receives an order, the order management module 220 may delay in offering the order to a picker if the timeframe is far enough in the future.

When the order management module 220 offers an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

During fulfillment of a user's order, the matching item module 225 determines whether a scanned item is an acceptable match to an ordered item in a user's order. To do so, the matching item module 225 may first identify a set of acceptable matches to the ordered item by proactively determining a set of matching items across a sometimes-large dataset of items during an “offline” phase. If a picked item does not match the scan code of the ordered item, is not found in the acceptable list of items, or is unknown, the matching item module 225 may determine, in-real time or near real-time, whether the scanned item is an acceptable match to the ordered item by utilizing a multi-modal model to determine if the image of the scanned item is a duplicate of or is interchangeable to the item in the order during an “online” phase.

The online system 140 may identify whether a picked item may be interchangeable, or force marked, with a corresponding picked item in the order when the picker is fulfilling the item at the retailer store. The incorrect handling of force marks may lead to catalog discrepancies, data quality issues, and edge case mishandlings. In one example, an online system 140 may detect an interchangeable item across a dataset by iterating through each item of the dataset to determine a set of matches within the database. However, such detection methods can be especially computationally intensive, expensive and time consuming for big datasets. Furthermore, such detection methods cannot be practically computed by the online system 140 in real-time while a picker is actively fulfilling an order. Thus, there exists a strong technical need for a method to proactively determine a match within a large database. Further, current online systems may improperly mark a matching item to the ordered item which may lead to inefficiencies when a picker fulfills an order for a user.

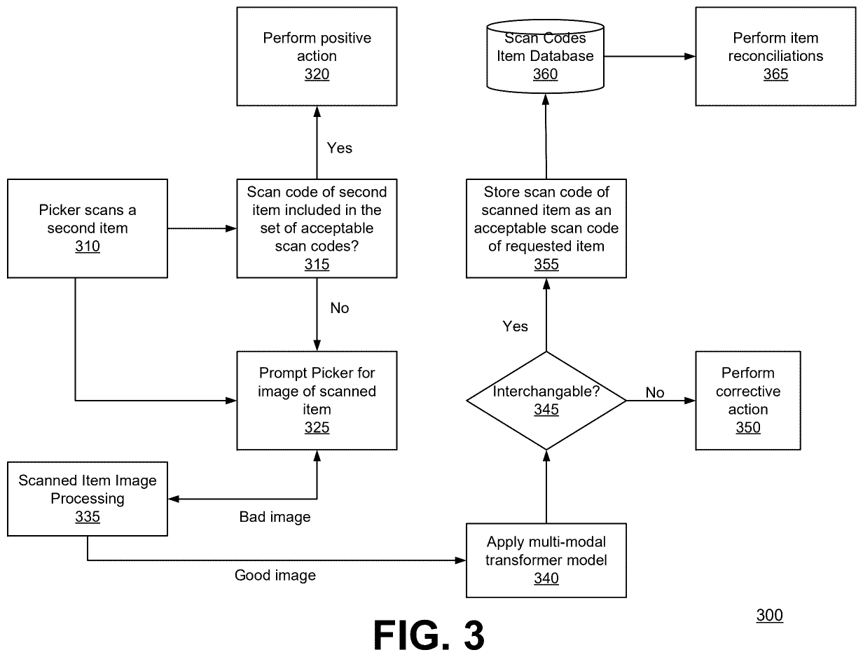

FIG. 3 illustrates a flowchart for identifying whether a scanned item is a match to the ordered item, in accordance with one or more aspects described herein.

A user of the online system 140 may request an order for a first item for a picker to fulfill. While fulfilling the order, the picker of the online system 140 scans 310 a second item instead of the item, wherein the scan includes the picker computing device capturing a scan code of the second item.

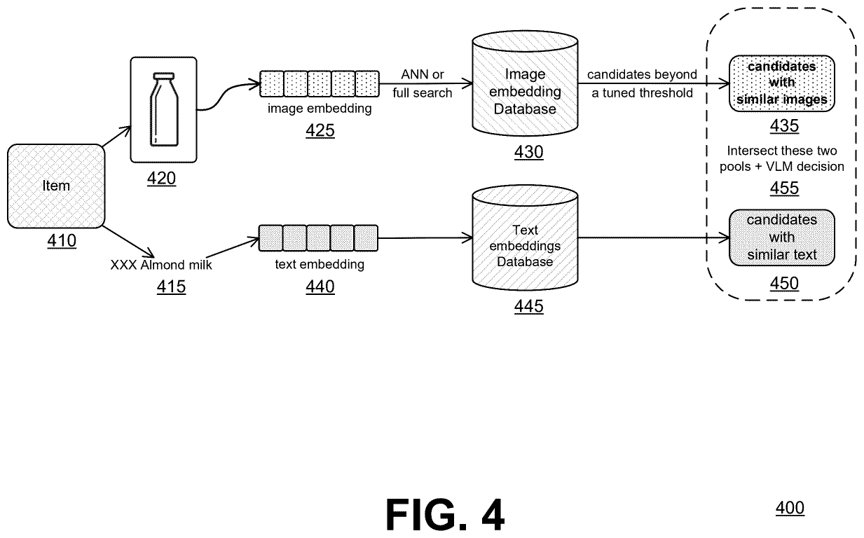

The matching item module 225 may determine whether the scan code is a duplicate of or is interchangeable to the ordered item. The matching item module 225 may identify 315 whether the scan code of the second item is included in the set of acceptable scan codes that were generated during an “offline” phase. The generation of the set of acceptable scan codes during the offline phase is further described in conjunction with FIG. 4.

In response to determining 320 that the scan code of the second item 310 is a positive match to the ordered item, the matching item module 225 performs a positive action. The positive action may include a responsive action to the positive match between the scanned item and the ordered item. A positive responsive action 320 may include actions such as sending a confirmation via a user interface (UI) to the picker client device 110 associated with the picker that the scanned item is an acceptable item to fulfill the corresponding item in the order, allowing the picker to fulfill the order with the scanned item, and the like.

In response to determining that the scan code of the second item 310 is not a positive match to the ordered item, the matching item module 225 prompts 325 the picker with the picker client device 110 to take an image of the scanned item during the “online phase.”

The steps described further illustrate the process of an online phase for determining, in real-time, whether the second item is an interchangeable item to the ordered item.

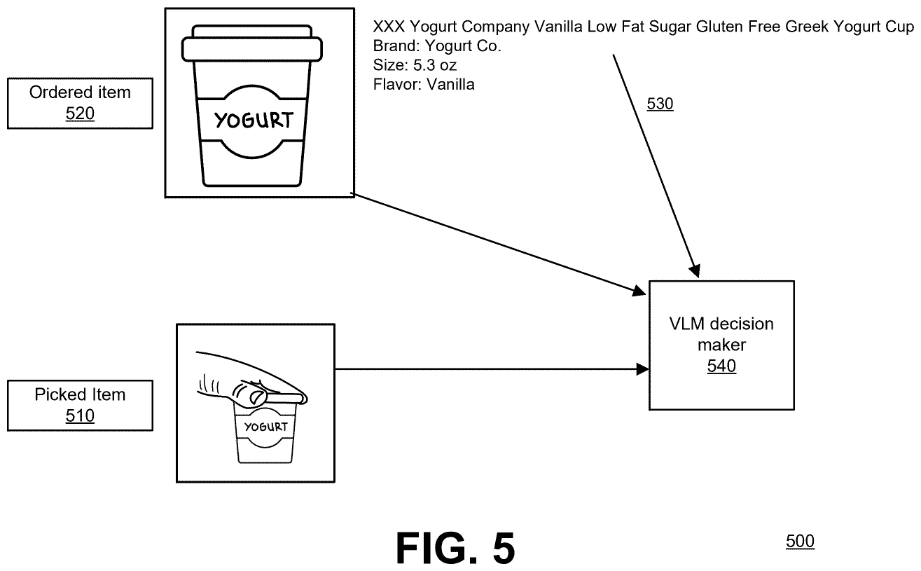

The matching item module 225 processes 335 an image of the scanned item. If the image of the item is a “bad” image, wherein the bad image may be a noisy image, hard to extract features from, or the like, the matching item module 225 may generate a prompt to the picker via the picker client device 110 for an improved image of the scanned item (e.g., an instruction to capture another image of the scanned item). If the item image is a “good” image (e.g., can be processed by the matching item module 225), the matching item module 225 may apply 340 a multi-modal transformer model with a request for a prompt to determine if an item is interchangeable, wherein the multi-modal transformer model may include, as input, at least the image of the scanned item. During the “online phase,” the inputs may also include as input text-description features extracted from the image of the scanned item. A further description of this process is described below in conjunction with FIG. 5, which is an example illustration of applying a multi-modal transformer model to determine whether a scanned item is interchangeable to the inputted item, in accordance with one or more embodiments.

The matching item module 225 may receive 345 a response from the multi-modal transformer model whether the scanned item is interchangeable 345 with the ordered item.

In response to receiving a response that the scanned item is not interchangeable with the ordered item, the matching item module 225 performs 350 a corrective action. The corrective action is a response to address the mismatch between the ordered item and the scanned item. The corrective action may include instructions for transmitting a UI to the picker computing device 110 indicating that the scanned item is not an acceptable match for the ordered item or instructions for transmitting a UI to request re-prompting the picker to take a new image of the scanned item.

In response to receiving that the scanned item is interchangeable with the ordered item 355, the matching item module 225 stores 355 the scan code of the scanned item as an acceptable scan code of the ordered item into a scan codes item database 360. Further, optionally, the matching item module 225 may include the scanned item in a list of acceptable items associated with the ordered item.

In response to receiving that the scanned item is interchangeable, the matching item module 225 may perform 365 item reconciliations. The item reconciliations for the acceptable second item include backend catalog adjusting and price reconciliations or fine-tuning of the multi-modal model by saving the image of the item with a positive label as a match between the ordered item and the scanned item, and the like.

In one or more arrangements, the matching item module 225 in conjunction with the machine learning training module 230 may perform fine-tuning of the LLM. To perform fine-tuning, the matching item module 225 obtains training data from the prompt to the multi-modal transformer model a to determine if an item is interchangeable, wherein the prompt includes as input at least the image of the scanned item, instances of picker instructions presented on a user interface in which the picker instructions were generated in conjunction with an LLM, and an output label wherein the output label indicates whether the scanned item is an interchangeable item.

The matching item module 225 may obtain such pairs of prompts and positive outputs for the training dataset. The matching item module 225 may encode the data into a set of input tokens, in which a token is a numerical vector representing a word, sub-word, phrase, pixels, latent pixels, in a latent space. When the transformer architecture of the machine-learned model (e.g., LLM) is of an autoregressive architecture, the LLM may be applied to generate one or more output tokens that correspond to the positive outputs. An output token is decoded to determine a probability that the decoded token corresponds to a corresponding token in the positive output.

The matching item module 225 may determine a loss function across the one or more output tokens that indicates a difference (e.g., logit difference) between the tokens in the positive outputs and the output tokens generated by the forward pass of the transformer model. As an example, the loss function may be an NLP loss for each token combined across one or more output tokens generated for the positive text. The matching item module 225 obtains one or more terms from the loss function and performs backpropagation to update parameters of the transformer architecture.

### Generating List of Acceptable Scan Codes During Offline Phase

In one or more examples, during the offline phase, the matching item module 225 may generate a set of acceptable scan codes associated with each item of a set of items by identifying a set of potential candidate items for the item. Specifically, the matching item module 225 accesses a database for a set of items of the online system 140. The matching item module 225 determines a set of potential candidate items of the set of items of the online system 140 associated with the ordered item. The potential candidate items may be a subset of the items wherein the matching item module 225 determines whether the candidate item is an acceptable match to the ordered item.

In one or more examples, the matching item module 225 may determine a set of candidate items by accessing historical data associated with the set of items of the online system 140. The historical data may include user engagement data from previous order histories and appeasement requests. The user engagement data may encompass information such as items the user interacted with on the online system 140—for example, items purchased, clicked on, or added to the user's cart.

In one or more arrangements, the matching item module 225 may determine a set of candidate items based on content describing the items by receiving image data and textual data associated with an item, generating a set of embeddings associated with the image and textual data of the item, and applying a nearest-neighbor search to the generated set of embeddings associated with the image and textual data of the item. FIG. 4 further describes generating a set of acceptable scan codes associated with the item by applying a nearest neighbor search to the generated set of embeddings for the candidate item to identify a potential set of candidate items.

In one or more examples, the set of candidate items may be determined by a combination of historical item data and content-based image and text data associated with the item. In other words, the matching item module 225 may determine the candidate items by a combination of the methods described above for determining a set of potential candidate items associated with the ordered item.

FIG. 4 is a flowchart for determining a set of acceptable scan codes associated with the ordered item during an offline phase, in accordance with one or more aspects described herein. FIG. 4 illustrates identifying a set of candidate items for a given item based on the content (e.g., text and image description of items). However, it is appreciated that in other arrangements, the process of FIG. 4 may be applied to other methods (e.g., user engagement-based methods) of generating the list of acceptable scan codes for the item.

The matching item module 225 may access a database for a set of items. The database may include images of the set of items and text descriptions of the set of items. As an example, the matching item module 225 accesses the database for an item 410 which includes a text description of the item 415 an image of the item 420.

For each ordered item, the matching item module 225 may apply an embedding model to the image associated with the item to generate a corresponding image embedding. As an example, the matching item module 225 applies an embedding model to the image of the item 420 to generate an image embedding 425: [0.23, −0.56, 1.12, . . . ]. In one or more embodiments, the embedding model may be trained to generate an embedding for an image to be close to a second embedding for a second image that is similar in content to the first image. In one or more instances, the embedding model may be configured as a transformer architecture, a deep neural network, a convolutional neural network, and the like.

For each ordered item, the matching item module 225 may apply an embedding model to the text description of the item to generate an embedding associated with the text description. As an example, the matching item module 225 applies an embedding model to the “XXX Almond Milk” description of the item 415 to generate text embedding 440:[0.36, −0.89, 0.12, . . . ].

In one or more instances, the embedding model used to generate an embedding for the text description may be a unified embedding model with the embedding model used to generate an embedding for the image. The unified embedding model may be an embedding model that generates an embedding for different entity or data modality types.

For each generated image embedding 425, the matching item module 225 stores the image embedding into a database 430. The matching item module 225 applies a nearest neighbor search to determine a set of nearest-neighbor image embeddings for the item 410. The matching item module 225 may determine a set of candidate items 435 for the example item 410 by identifying a subset of nearest-neighbor items from the set of nearest-neighbor image embeddings that have embeddings within a threshold distance from the generated image embedding of the ordered item 410.

For each generated text embedding 440, the matching item module 225 stores the text embedding into a database 445. The matching item module 225 may apply a nearest neighbor search to determine a set of nearest-neighbor text embeddings for the item 410. The matching item module 225 may determine a set of candidate items 450 for the example item 410 by identifying a subset of nearest-neighbor items from the set of nearest-neighbor text embeddings that have embeddings within a threshold distance from the generated text embedding of the ordered item 410.

The matching item module 225 may combine the determined candidate items with similar images to the ordered item 435 to the determined candidate items with similar text to the ordered item 450. The matching item module 225 may access the associated images and text descriptions of the combined set of candidate items. The matching item module 225 includes as input to the multi-modal model, the combined set of candidate items (including the image and text descriptions of the candidate items), with a request to determine whether the candidate item is an acceptable match or is interchangeable with the ordered item to a multi-modal model. The matching item module 225 receives as output from the multi-modal model, a set of acceptable items that are an acceptable match to or interchangeable with the ordered item.

The matching item module 225 may access a database of the online system 140 to retrieve scan codes associated with each item of the set of acceptable items of the online system 140 to generate a set of acceptable scan codes associated with the ordered item. The matching item module 225 stores the set of acceptable scan codes in association with the ordered item for a database of the online system 140. This process may be repeated for other items in the catalogue database, and a list of acceptable scan codes for each item are stored in association with the items. For an ordered item, the list of acceptable scan codes for the ordered item may be retrieved when the picker user picks an item for the ordered item, as described in conjunction with step 315 in FIG. 3.

FIG. 5 is an example illustration of the online approach for applying a multi-modal transformer model to determine whether a scanned item is interchangeable to an ordered item during an online phase, in accordance with one or more aspects described herein. FIG. 5 illustrates a flowchart for prompting a multi-modal LLM to identify duplicates or interchangeable items, according to one or more embodiments. In one or more embodiments, the prompt to the LLM includes an image of the picked item obtained from the picker device 510 (as described in conjunction with step 325 of FIG. 3), the image or text description of the ordered item (e.g., obtained from the catalog database) 520, and a request to identify whether the picked item and the ordered item are duplicates or interchangeable items 530. As an example, the prompt to the multi-modal model, or a vision language model (VLM), for the ordered item 520 may be:
“Based on the received image of the ordered item for an XXX Yogurt Company Vanilla Low Fat Sugar Gluten Free Greek Yogurt Cup Brand: Yogurt Co. Size: 5.3 oz Flavor: Vanilla, determine whether the picked item is interchangeable to the ordered item. [Image of ordered item.] [Image of picked item.]”

The multi-modal transformer model (e.g., VLM) decision maker 540 may receive the prompt and generate a response indicating whether the picked item is interchangeable with the ordered item. Based on the response, if the picked item is an interchangeable item, the scan code of the picked item may be further stored in the database as an acceptable scan code for the ordered item, as described in conjunction with step 355 of FIG. 3. If the picked item is not an interchangeable item, a corrective action may be taken (as described in conjunction with step 350 of FIG. 3), and the purchase of the picked item may not be approved.

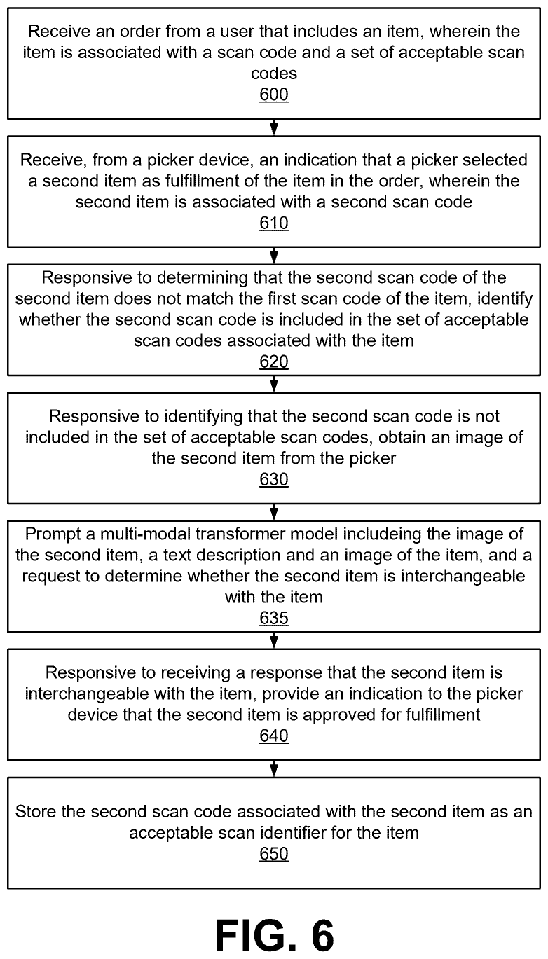

FIG. 6 is a flowchart for a matching item module, in accordance with some aspects described herein. Alternative arrangements may include more, fewer, or different steps from those illustrated in FIG. 6 and the steps may be performed in a different order from that illustrated in FIG. 6. These steps may be performed by an online system (e.g., online system 140). Additionally, each of these steps may be performed automatically by the online system 140 without human intervention.

The matching item module receives 600 an order from a user that includes an item, wherein the item is associated with a scan code and a set of acceptable scan codes. The matching item module 225 receives 610, from a picker device, an indication that a picker selected a second item as fulfillment of the item in the order, wherein the second item is associated with a second scan code. The matching item module, responsive to determining that the second scan code of the second item does not match the first scan code of the item, identifies 620 whether the second scan code is included in the set of acceptable scan codes associated with the ordered item. The matching item module responsive to identifying that the second scan code is not included in the set of acceptable scan codes, obtains 630 an image of the second item from the picker and prompts 635 a multi-modal transformer model, wherein the prompt includes the image of the second item, a text description or an image of the item, and a request to determine whether the second item is interchangeable with the ordered item. The matching item module responsive to receiving a response that the second item is interchangeable with the ordered item, provides 640 an indication to the picker device that the second item is approved for fulfillment. The matching item module stores 650 the second scan code associated with the second item as an acceptable scan identifier for the ordered item.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
receiving, by an online computer system having at least one processor and memory, an order from a user that includes an item, wherein the item is associated with a scan code and a set of acceptable scan codes;
receiving, by the online computer system and from a picker computing device, an indication that a picker selected a second item as fulfillment of the item in the order, wherein the second item is associated with a second scan code and the indication is based on a scan of the second scan code performed by the picker computing device;
responsive to identifying that the second scan code of the second item does not match the scan code of the item, identifying whether the second scan code is included in the set of acceptable scan codes associated with the item;
responsive to identifying that the second scan code is not included in the set of acceptable scan codes, obtaining an image of the second item from the picker computing device;
prompting a multi-modal transformer model with a first prompt, wherein the first prompt includes the image of the second item, a text description of the item from a catalogue database, an image of the item from the catalogue database, and a request to determine whether the second item is interchangeable with the item;
responsive to receiving a response that the second item is interchangeable with the item, providing an indication to the picker computing device that the second item is approved for fulfillment; and
storing the second scan code associated with the second item as an acceptable scan code for the item to update the set of acceptable scan codes.

2. The method of claim 1, further comprising:
accessing a database for a set of candidate items, wherein the database includes an image and a text description associated with a candidate item of the set of candidate items;
for each candidate item:
generating one or more embeddings for the candidate item by applying one or more embedding models to the text description and the image associated with the candidate item;
generating one or more embeddings for the item by applying the one or more embedding models to the text description and the image associated with the item;
identifying a subset of candidate items, wherein the one or more embeddings for the subset of candidate items are within a threshold distance from the one or more embeddings of the item; and
generating the set of acceptable scan codes for the item based at least on the subset of candidate items.

3. The method of claim 2, further comprising:
for each identified candidate item:
prompting the multi-modal transformer model with a second prompt, wherein the second prompt includes a request to determine whether the identified candidate item is interchangeable with the item;
responsive to receiving a response that the identified candidate item is interchangeable with the item; and
storing a scan code for the identified candidate item as part of the set of acceptable scan codes in association with the item.

4. The method of claim 1, wherein the first prompt does not include a text description of the second item.

5. The method of claim 1, further comprising:
prompting the picker to obtain a first image of the second item;
identifying whether the first image is an acceptable image; and
responsive to determining that the first image is not an acceptable image, prompting the picker to obtain the image of the second item.

6. The method of claim 1, further comprising:
responsive to storing the second code associated with the second item, performing a corrective action, wherein the corrective action comprises readjusting pricing of the item according to a pricing of the second item.

7. The method of claim 1, further comprising:
confirming that the second item is interchangeable with the item;
creating a training example, wherein the training example includes as input the first prompt and an output label, wherein the output label indicates that the second item is interchangeable with the item; and
fine-tuning a set of parameters of the multi-modal transformer model using the training example.

8. A non-transitory computer-readable storage medium storing computer instructions, the computer instructions, when executed by one or more processors, cause the one or more processors to:
receive an order from a user that includes an item, wherein the item is associated with a scan code and a set of acceptable scan codes;
receive, by an online computer system and from a picker computing device, an indication that a picker selected a second item as fulfillment of the item in the order, wherein the second item is associated with a second scan code and the indication is based on a scan of the second scan code performed by the picker computing device;
responsive to identifying that the second scan code of the second item does not match the scan code of the item, identify whether the second scan code is included in the set of acceptable scan codes associated with the item;
responsive to identifying that the second scan code is not included in the set of acceptable scan codes, obtain an image of the second item from the picker computing device;
prompt a multi-modal transformer model with a first prompt, wherein the first prompt includes the image of the second item, a text description of the item from a catalogue database, an image of the item from the catalogue database, and a request to determine whether the second item is interchangeable with the item;
responsive to receiving a response that the second item is interchangeable with the item, provide an indication to the picker computing device that the second item is approved for fulfillment; and
store the second scan code associated with the second item as an acceptable scan code for the item to update the set of acceptable scan codes.

9. The non-transitory computer-readable storage medium of claim 8, wherein the computer instructions, when executed by the one or more processors cause the one or more processors to:
access a database for a set of candidate items, wherein the database includes an image and a text description associated with a candidate item of the set of candidate items;
for each candidate item:
generate one or more embeddings for the candidate item by applying one or more embedding models to the text description and the image associated with the candidate item;
generate one or more embeddings for the item by applying the one or more embedding models to the text description and the image associated with the item;
identify a subset of candidate items, wherein the one or more embeddings for the subset of candidate items are within a threshold distance from the one or more embeddings of the item; and
generate the set of acceptable scan codes for the item based at least on the subset of candidate items.

10. The non-transitory computer-readable storage medium of claim 9, wherein the computer instructions, when executed by the one or more processors cause the one or more processors to:
for each identified candidate item:
prompt the multi-modal transformer model with a second prompt, wherein the second prompt includes a request to determine whether the identified candidate item is interchangeable with the item;
responsive to receiving a response that the identified candidate item is interchangeable with the item; and
store a scan code for the identified candidate item as part of the set of acceptable scan codes in association with the item.

11. The non-transitory computer-readable storage medium of claim 8, wherein the first prompt does not include a text description of the second item.

12. The non-transitory computer-readable storage medium of claim 8, wherein the computer instructions, when executed by the one or more processors, cause the one or more processors to:
prompt the picker to obtain a first image of the second item;
identify whether the first image is an acceptable image; and
responsive to determining that the first image is not an acceptable image, prompt the picker to obtain the image of the second item.

13. The non-transitory computer-readable storage medium of claim 8, wherein the computer instructions, when executed by the one or more processors cause the one or more processors to:
responsive to storing the second code associated with the second item, perform a corrective action, wherein the corrective action comprises readjusting pricing of the item according to a pricing of the second item.

14. The non-transitory computer-readable storage medium of claim 8, wherein the computer instructions, when executed by the one or more processors cause the one or more processors to:
confirm that the second item is interchangeable with the item;
create a training example, wherein the training example includes as input the first prompt and an output label, wherein the output label indicates that the second item is interchangeable with the item; and
fine-tune a set of parameters of the multi-modal transformer model using the training example.

15. A computer system comprising:
a processor; and
a non-transitory computer readable storage medium storing instructions that, when executed by the processor, cause the processor to perform actions comprising:
receiving an order from a user that includes an item, wherein the item is associated with a scan code and a set of acceptable scan codes;
receiving, by an online computer system and from a picker device, an indication that a picker selected a second item as fulfillment of the item in the order, wherein the second item is associated with a second scan code and the indication is based on a scan of the second scan code performed by the picker computing device;
responsive to identifying that the second scan code of the second item does not match the scan code of the item, identifying whether the second scan code is included in the set of acceptable scan codes associated with the item;
responsive to identifying that the second scan code is not included in the set of acceptable scan codes, obtaining an image of the second item from the picker computing device;
prompting a multi-modal transformer model with a first prompt, wherein the first prompt includes the image of the second item, a text description of the item from a catalogue database, an image of the item from the catalogue database, and a request to determine whether the second item is interchangeable with the item;
responsive to receiving a response that the second item is interchangeable with the item, providing an indication to the picker computing device that the second item is approved for fulfillment; and
storing the second scan code associated with the second item as an acceptable scan code for the item to update the set of acceptable scan codes.

16. The computer system of claim 15, further comprising:
accessing a database for a set of candidate items, wherein the database includes an image and a text description associated with a candidate item of the set of candidate items;
for each candidate item:
generating one or more embeddings for the candidate item by applying one or more embedding models to the text description and the image associated with the candidate item;
generating one or more embeddings for the item by applying the one or more embedding models to the text description and the image associated with the item;
identifying a subset of candidate items, wherein the one or more embeddings for the subset of candidate items are within a threshold distance from the one or more embeddings of the item; and
generating the set of acceptable scan codes for the item based at least on the subset of candidate items.

17. The computer system of claim 15, further comprising:
for each identified candidate item:
prompting the multi-modal transformer model with a second prompt, wherein the second prompt includes a request to determine whether the identified candidate item is interchangeable with the item;
responsive to receiving a response that the identified candidate item is interchangeable with the item; and
storing a scan code for the identified candidate item as part of the set of acceptable scan codes in association with the item.

18. The computer system of claim 15, wherein the first prompt does not include a text description of the second item.

19. The computer system of claim 15, further comprising:
prompting the picker to obtain a first image of the second item;
identifying whether the first image is an acceptable image; and
responsive to determining that the first image is not an acceptable image, prompting the picker to obtain the image of the second item.

20. The computer system of claim 15, further comprising:
responsive to storing the second code associated with the second item, performing a corrective action, wherein the corrective action comprises readjusting pricing of the item according to a pricing of the second item.
